(19) United States
(12) Patent Application Publication
(10) Pub. No.: US 2008/0099057 A1
(43) Pub. Date: May 1, 2008

(54) Method and Device for Cleaning a Liquid Aspiration and Dispense Probe

(75) Inventors: William David Dunfee, Newark, DE (US); Antoine Elias Haddad, Newark, DE (US); Robert Franklin Hazelwood, Newark, DE (US); Robert Eugene Myers, Newark, DE (US); Richard Renrong Zhang, Hockessin, DE (US)

Correspondence Address: DADE BEHRING INC.;LEGAL DEPARTMENT, 1717 DEERFIELD ROAD, DEERFIELD, IL, 60015, US

(73) Assignee: DADE BEHRING INC., Deerfield, IL (US)

(21) Appl. No.: 11/553,583

(22) Filed: Oct. 27, 2006

(51) Int. Cl. B08B 3/00

(52) U.S. Cl. 134/94.1; 134/198

(57) ABSTRACT

Cleaning a liquid sample probe with a cleansing station having sources of air, cleansing solution, bath and shower water in a two-well cleansing body. The cleansing body comprises a multifunctional plate having features to provide both a wall of shower water and thin sheets of high velocity air that provide thorough cleaning of the sample probe

### FIELD OF THE INVENTION

The present invention is related to the field of liquid probes and more particularly to a method and apparatus for cleaning liquid sample and reagent probes More specifically, the present invention provides a probe cleansing station using at least one water rinse and cleaning solution. Although not limited to the field of automated clinical analyzers, the present invention is particularly useful when applied therein

### BACKGROUND OF THE INVENTION

Automated clinical chemistry analyzers are well known in the art and generally use an aspirating means such as a sampling tip, or probe or needle, to transfer predetermined volumes of liquid samples or liquid reagents between receptacles, such as sample containers, reagent containers and reaction cuvettes disposed at various locations on the analyzer. The aspirating means, hereinafter referred to as a sample probe, is typically an elongated, needle-like member having a hollow passage whereby liquid may be drawn into and dispensed from the sample probe using appropriate pumping resources. Such sample probes may be used to aspirate and deliver liquid samples or one or more liquid reagents between receptacles, e.g., from containers to one or more reaction cuvettes, where a chemical analysis of the sample is conducted, either with the same sample probe or with one or more liquid sample probes

A common problem in such aspirating means is the risk of liquid “adhesion” and/or “carryover”. Carryover occurs when a probe having residual traces of a previously dispensed sample or reagent is introduced into volume of a different reagent or sample. Carryover is usually manifested as the contamination of a given reagent supply or a given sample volume by the introduction of other reagents or samples that remain on or in or are adsorbed by the sample probe. Adhesion occurs when a portion of an aspirated reagent or sample adheres to the exterior surface of a sample probe and is not appropriately removed therefrom.

To minimize adhesion and/or carryover, the sample probe is generally cleaned by washing prior to subsequent operations. Washing is typically accomplished by lowering the sample probe into a cleaning resource that contains an appropriate cleaning liquid solution The cleaning liquid solution washes the exterior of the sample probe. The interior of the sample probe is cleaned by aspirating and discharging the cleaning solution. Alternatively, the sample probe may be cleaned by discharging a purge liquid through the sample probe into a drain. Washing may use a jet of drying air forced under pressure through the sample probe or at the exterior surface thereof. In this manner the volume of residual carryover on the exterior surface or the interior of the sample probe is minimized. As a practical matter, cleaning of both the sample probe and cleaning resource is required to preserve proper operation.

Analysis instruments having a typical sample probe cleansing station are described in. U.S. Pat. No. 3,964,526; U.S. Pat. No. 4,318,885; U.S. Pat. No. 3,552,212; U.S. Pat. No. 4,323,537.

A common problem with sample probe washing, however, is residual liquid or contaminants may be adsorbed on the sample probe despite washing. This residue may mix with subsequent samples or reagents drawn into the sample probe and can result in the introduction of a contaminated sample or reagent. Furthermore, the presence of additional residual droplets of sample or reagent on the exterior or interior of the sample probe may cause unwanted additional liquid to be introduced into a destination receptacle. This unwanted residue may mix with subsequent sample or reagents drawn into the sample probe and interfere with chemical analyses. Sample probe cleaning is a particularly troublesome problem when exacerbated by the trend to smaller and smaller sample volumes. A minute volume of cleaning liquid solution may remain within or on the exterior surface of a sample probe causing a corresponding deficiency in the volume of sample liquid later transferred to a reaction vessel. Such a sample volume deficiency may create serious analytical errors in automated assays for calcium, magnesium and glucose, in particular.

U.S. Pat. No. 5,297,794 addresses this problem by using flushing water in combination with an inclined waterway channel in which the sample probe is immersed. As the sample probe traverses the waterway channel, it is withdrawn and liquid communication between the waterway and the sample probe is broken and cleaning ceases, leaving liquid droplets on the sample probe.

U.S. Pat. No. 5,408,891 also addresses this problem and used a wash collar with (1) pressurized water supplied through the inner bore of a fluid sample probe to wash the inside of the sample probe, and (2) a separate supply of water washing the sample probe and the exterior of the sample probe when positioned in a small central chamber within the wash collar. The wash collar is of complex design including five differently shaped portions through a central bore in which the sample probe moves. The water is drawn away from the sample probe and out of the wash collar through a vacuum port located in the lower portion of the bore and in communication with a vacuum source. Unfortunately, only a small portion of external air enters the wash collar from the direction of sample probe insertion, the majority coming from an enlarged lowermost portion of the wash collar bore. This does not permit thorough cleaning of the sample probe.

U.S. Pat. No. 5,506,142 provides a probe wash in which a turbulent flow is created in the probe by means of a simultaneous introduction of pressurized air and water. The turbulent flow may also be created by introduction of bursts of the air and water in rapid sequence. A pressurized gas stream of short duration blows the residue of the previous sample out of the probe prior to washing with additional diluent liquid.

U.S. Pat. No. 5,827,744 cleans a sample probe within a bore and pumps wash liquid solution into the bore and vacuums the cleaning liquid solution from the upper portion of the bore. Air is drawn through said annular gap so that a cleaning air flow from outside the wash probe is created between the exterior sample probe surface and the bore; when the sample probe is removed from the wash body, the air flow cleans liquid solution from the exterior surface of the sample probe. A wash or purging liquid solution may be pumped through the hollow portion of the sample probe into the bore before cleaning liquid solution is pumped into the bore.

It is believed to be advantageous to provide a cleaning method which effectively eliminates extraneous material from the full interior and the full exterior of the sample probe while at the same time not unduly adding to the complexity of washing resources nor detracting from the throughput of the instrument.

### SUMMARY OF THE INVENTION

Many of these prior art deficiencies are reduced with the present invention which relates to a method for cleaning a liquid sample probe moveable into and out of a cleansing station consisting of a supply tubing bundle for supplying air, cleansing solution and bath and shower water; vacuum tubing for evacuating waste; and a two-well cleansing body in which probe cleansing, rinsing and drying take place. The cleansing station comprises a multifunctional plate having features to provide both a wall of shower water and thin sheets of high velocity air that provide thorough cleaning of the sample probe.

### BRIEF DESCRIPTION OF THE DRAWINGS

The invention will be more fully understood from the following detailed description thereof taken in connection with the accompanying drawings which form a part of this application and in which:

FIG. 1 is a schematic plan view of an automated analyzer in which the present invention my be advantageously employed;

FIG. 2 is a perspective view of the probe cleansing station exemplary of the present invention;

FIG. 3 is an exploded perspective view of the probe cleansing station of FIG. 2;

FIG. 4 is a sectional view of the cleansing body portion of the probe cleansing station of FIG. 2;

FIG. 5 is a side elevation view of the cleansing body portion of FIG. 4 showing internal tubings and ports in phantom lines;

FIG. 5A is a sectional view of the cleansing body portion of FIG. 4 taken along line A-A of FIG. 5;

FIG. 5B is a sectional view of the cleansing body portion of FIG. 4 taken along line B-B of FIG. 5;

FIG. 5C is a sectional view of the cleansing body portion of FIG. 4 taken along line C-C of FIG. 5;

FIG. 6 is a top plan view of a multifunctional plate of the probe cleansing station of FIG. 2,

FIG. 6A is a sectional view of the multifunctional plate of FIG. 6 taken along lines A-A; and,

FIG. 6B is a sectional view of the multifunctional plate of FIG. 6 taken along lines B-B.

### DETAILED DESCRIPTION OF THE INVENTION

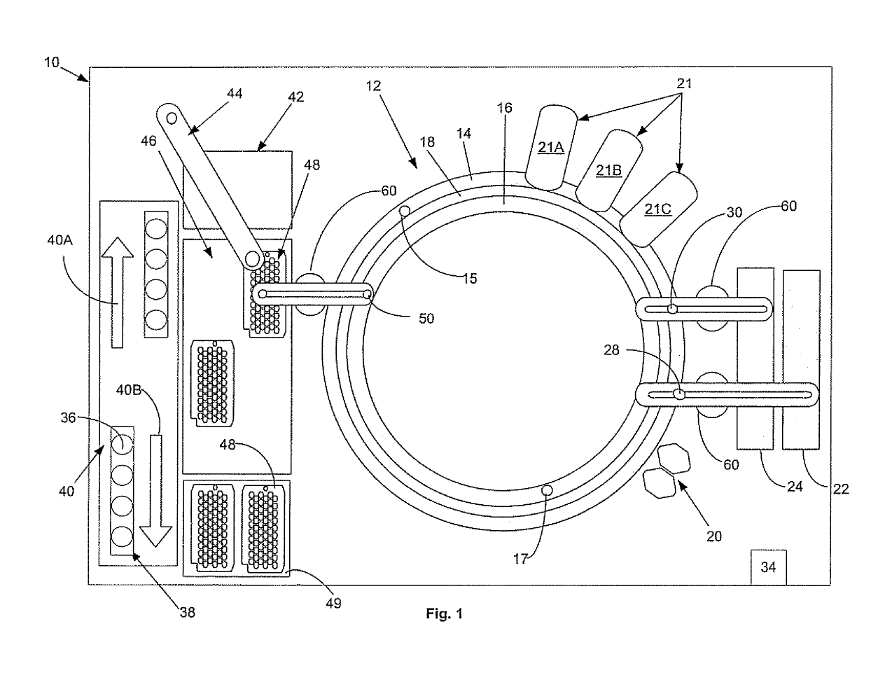

FIG. 1 shows schematically the elements of a conventional automatic chemical analyzer 10 in which the present invention may be advantageously practiced. Analyzer 10 comprises a reaction carousel 12 supporting an outer cuvette circle 14 of cuvette ports 15 and an inner cuvette circle 16 of cuvette ports 17, the outer cuvette circle 14 and inner cuvette circle 16 being separated by a groove 18. Cuvette ports 15 are adapted to receive a plurality of reaction cuvettes typically formed as small, flat walled, U-shaped containers having an open central reaction portion closed at the bottom and with an opening at the top to allow the addition of reagent and sample liquids. Cuvette ports 17 are adapted to receive a plurality of similar reaction cuvettes except being round walled. Reaction carousel 12 is rotatable using stepwise movements in a constant direction at a constant velocity, the stepwise movements being separated by a constant dwell time during which dwell time, carousel 12 is maintained stationary and individual computer controlled electro-mechanical devices 20, such as sensors, reagent add stations, mixing stations, and the like, perform the actions required in well known clinical assays. Such devices and their control and operation are described, for example, in U.S. Pat. Nos. 5,876,668, 5,575,976 and 5,482,861 and the references cited therein.

Two temperature-controlled reagent storage areas 22 and 24 each store a plurality of reagent containers containing reagents as necessary to perform a given assay. Shuttle means (not shown) move individual reagent containers to probes 28 and 30. Storage areas 22 and 24 may be conveniently located external to the circumference of outer cuvette circle 14. Various assay analyzing means 21 may be located proximate outer cuvette carousel 14 and are adapted to measure light absorbance in or emission from cuvettes 15 at various wavelengths, from which the presence of analyte in the sample liquid may be determined using well-known analytical techniques. Means 21 typically comprise conventional photometric 21A, fluorometric 21B or luminescent measuring devices 21C adapted to perform an interrogating measurement at any convenient time interval during which reaction carousel 12 is stationary.

Analyzer 10 is controlled by computer 34 based on software written in a machine language, like that used on the Dimension® clinical chemistry analyzer sold by Dade Behring Inc, of Deerfield, Ill., and widely used by those skilled in the art of computer-based electromechanical control programming. Computer 34 is interlinked using known interface software applications with a Laboratory Information System (LIS) and/or a Hospital Information System (HIS) so that information concerning patients, patient assay requests, assay results, analyzer status, and the like, may be immediately accessible as needed by laboratory personnel. Computer 34 includes an operator interface module typically comprising a keyboard and monitor or a flat-panel touch viewing screen or the like, on which information about the operational status of analyzer 10 as described herein may be called up and displayed or by which analyzer 10 may be automatically controlled to perform assays and related operations given the identity of a patient sample and assay requests, results and desired on-board storage conditions.

Conventional operations such as controlling the movement and placement of sample rack and tubes and aliquot arrays, liquid aspiration and dispensing operations by sampling arms and probes, coordination of alignment and activation of drive, rotation, extracting and lifting motors, the role of proximity and location sensors, bar-code readers in providing operational status data to computer 34 and the like are well known in the art and have been described in readily available publications.

As seen in FIG. 1, incoming sample samples to be tested are typically contained in sample containers or tubes 36 supported in sample tube racks 38 transportable by a sample tube rack transport system 40 comprising incoming lane 40A and outgoing lane 40B. Bar coded indicia on sample tubes 36 are scanned using a conventional bar code reader to determine, optionally among other items, a patient's identity, and if a sample aliquot is desired to be retained inside an environmental storage chamber 42, described hereinafter.

Aliquotting probe 44 supports a conventional liquid aspiration and dispense probe and is rotatably mounted so that movement of aliquotting probe 44 describes a line intersecting the original patient sample tubes 36 transported by sample tube transport system 40 and an aliquot array transport system 46. Aliquot array transport system 46 comprises an aliquot array storage and handling unit 49 adapted so that aliquot arrays 48 having a number of small sample wells therein may be automatically transferred from a vertical stack onto a planar transport member having a number of sampling tracks formed therein. Each aliquot array 48 is marked, for example with machine-readable indicia so that the identity of the array 48 and thus the identity and location of each patent sample aliquot within each well may be tracked and located using routine computer-based tracking programs within computer 34. Optionally, array 48 may be covered with a lidstock having I-shaped, X-shaped, or star-shaped slits forming adjacent segments that act to partially seal around an aspiration probe. Bi-directional aliquot array drive motors are positioned beneath array transport member and are controlled by computer 34 to shuttle aliquot arrays 48 lengthwise within test sampling tracks to a test sampling location.

Aliquotting probe 44 is conventionally controlled by computer 34 to aspirate liquid sample from sample tubes 36 and to dispense one or more aliquot portions of the original patient sample into one or more of wells in aliquot arrays 48, depending on the quantity of sample required to perform the requisite assays and to provide for at least one aliquot portion to be retained by analyzer 10 within environmental chamber 42. In an exemplary embodiment, two separate sample aliquot portions are dispensed into two separate wells in an aliquot array 48. Subsequent to dispensing aliquot portions of an original patient sample into wells, drive motors are controlled by computer 34 to position aliquot array 48 at a test sampling position within vessel array tracks below an aliquot sampling probe 50 located proximate reaction carousel 12. Aliquot sampling probe 50 is controlled by computer 34 to aspirate a requisite test sample aliquots(s) into reaction cuvettes in cuvette ports 15 and 17 in order to perform the original menu of assays prescribed for the sample. Sampling probe 50 is then positioned within cleansing station 52 exemplary of the present invention whereby sampling probe 50 is cleansed.

Reagent probes 28 and 30 of conventional design draw reagent from an appropriate reagent cartridge 20, deposit reagent within a predetermined reaction cuvette 15 or 17 and ultrasonically mix the reagent with chase water. The reagent probes 28 and 30 are then positioned within cleansing station 52 exemplary of the present invention where each reagent probe 28 or 30 is cleaned.

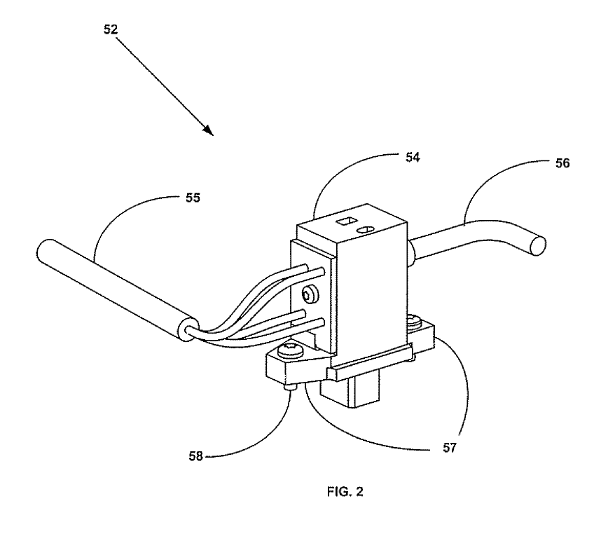

As illustrated in FIG. 2, cleansing station 52 may be seen to comprise a cleansing body 54 in which probe cleansing, rinsing and drying take place, cleansing body 54 having attached thereto a supply tubing bundle 55 for supplying air, cleansing solution, shower water and bath water and vacuum tubing 56 for evacuating waste. A baseplate portion 57 is provided to facilitate mounting of cleansing station 52 within the locations shown in FIG. 1 using mounting screws 58.

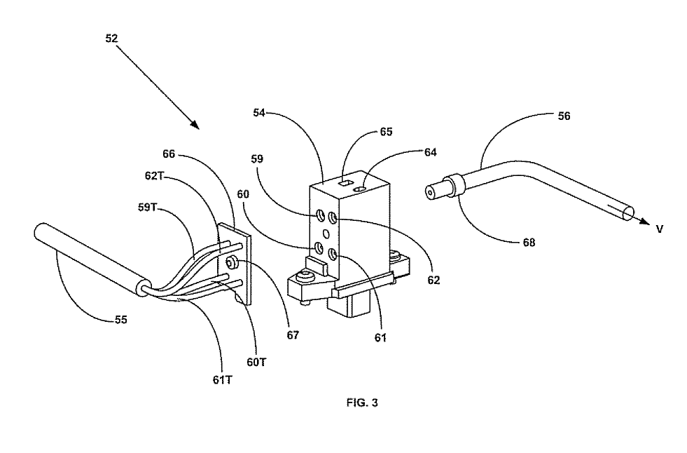

FIG. 3 is an exploded view of the cleansing station 52 of FIG. 2 and illustrates a number of important features of cleansing body 54 as specifically comprising a shower water port 59, a bath water port 60, an pressurized air feed port 62, a cleansing liquid solution port 61, a cleansing well opening 64 and a rinsing well opening 65. Supply tubing bundle 55 comprises four supply tubes for supplying shower water 59T, bath water 60T, cleanser solution 61T, and pressurized air 62T from conventional sources □therefore (not shown). These four supply tubes are bundled within a gang plate 66 providing tight sealing surfaces and a minimal connection area. A mounting screw 67 in the center of plate 66 provides uniform pressure on the four tubing connections. An asymmetrical notch (not shown) on gang plate 66 makes the installation error-proof. Vacuum tubing 56 is connected to a vacuum pump source of vacuum V and is connected to cleansing body 54 by a vacuum port 68. In an exemplary embodiment, cleansing body 54 is constructed of multiple separate clear plastic layers consisting of precisely machined internal channels as described above, the plastic layers being molecularly bonded to prevent air and fluid leaks.

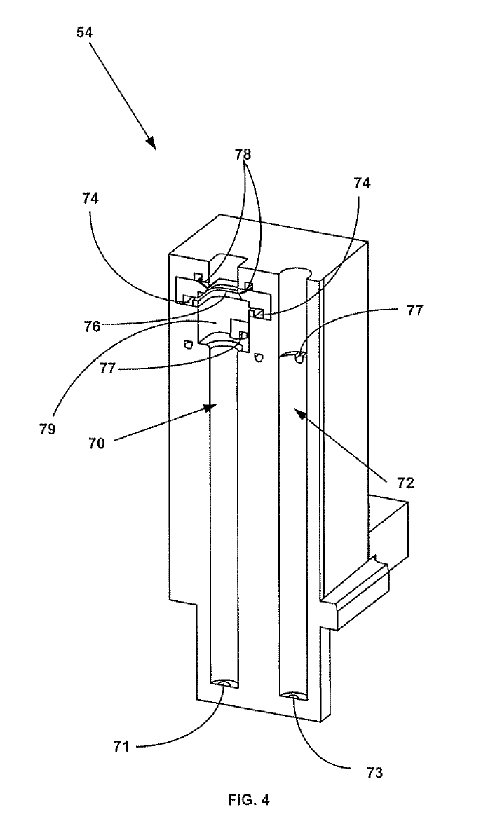

FIG. 4 shows cleansing body 54 constructed in accordance with a preferred embodiment and having a first vertically oriented, elongate open rinsing well 70 extending partially therethrough and having an enlarged open shower portion 79 at the upper end thereof for probe 50 to access, first open well 70 capable of providing water rinsing and drying, and a second vertically oriented, elongate open cleansing well 72 extending partially therethrough for probe 50 to access for cleansing solution. Rinsing well 70 is in vacuum and fluid communication with vacuum tubing 56 and water tubings 59T and 60T by means of opposed vacuum port 68 and fluid ports 59 and 60. Cleansing well 72 is in vacuum and fluid communication with vacuum tubing 56 and cleansing liquid solution tubing 61T by means of opposed vacuum and fluid ports 68 and 61, respectively. Bath water and cleansing solution are fed through ports 71 and 73 at the bottom of the open wells 70 and 72, ports 71 and 73 being routed internally within cleansing body 54 from bath water port 60 and cleanser solution port 61 to first open well 70 for water rinsing and a second open well 72 for cleansing, respectively.

A pair of vacuum ports 77 are formed in the upper portion of wells 70 and 72 at a predetermined distance above the bottom of wells 70 and 72 so that a “static level” pool of bath water and cleansing solution is maintained in both wells 70 and 72 (liquid feed is at the bottom of the pool through ports 71 and 73, and vacuum take-off is at the top via ports 77). Cleaning waste as well as rinse water are routed internally to single vacuum tubing 56 thereby reducing the overall vacuum requirement because only well 70 or 72 is in use at one time.

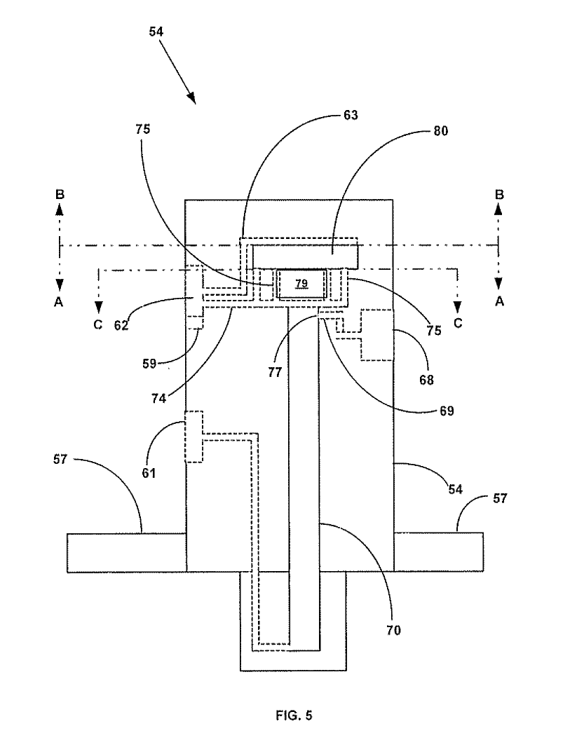

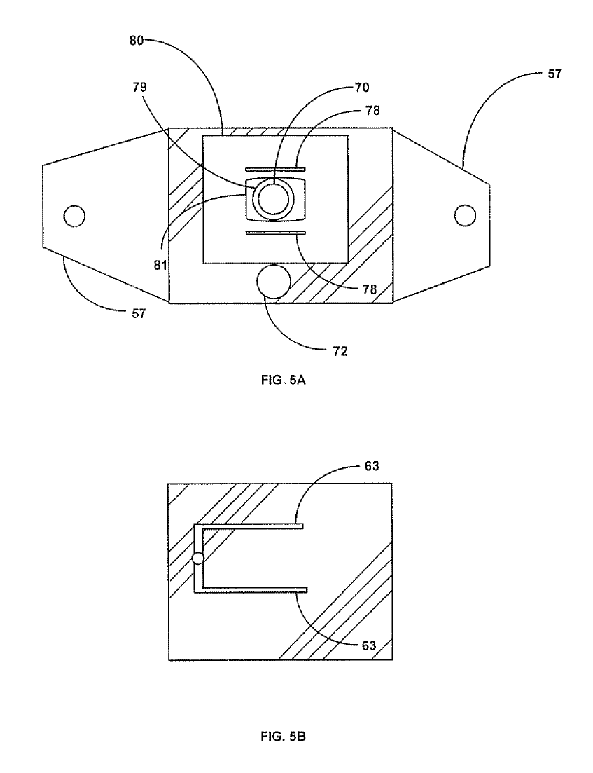

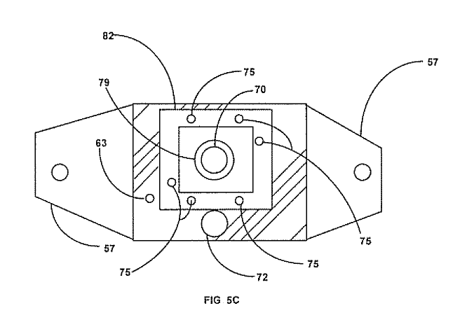

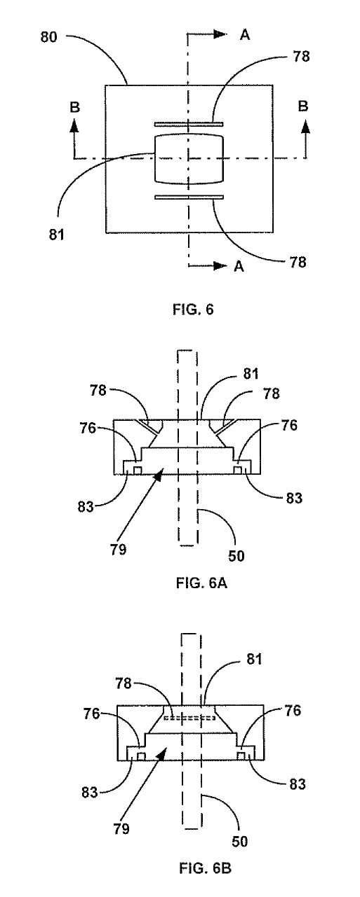

A key feature of the present invention is multifunctional plate 80 taken in combination with shower feed port 59 and air feed port 62 so as to provide both a shower of rinsing water onto the exterior of a probe 50 inserted into cleansing station 52 and a pressurized flow of drying air. To provide these features, multifunctional plate 80 is encapsulated within the cleansing body 54 during the manufacturing process. Precise temperature control is employed to reduce the stress between the plastic and the metal and to ensure an air-tight seal. As seen in FIG. 5, air feed port 59 is connected to a tubing which branches into a U-shaped pair of two channels 63 that are directed into contact with two air slits 78 formed in the top of a multifunctional plate 80 described hereinafter. Channels 63 feed air slits 78 (FIG. 6A) which are oriented at a 60 degree angle relative to the direction of probe 50 insertion (vertical axis of well 70). Pressurized air flowing through slits 78 forms thin sheets of high velocity air that effectively wipe off any water droplets on probe 50 outer surface as probe 50 is withdrawn from rinse well 70. It has been found that thin sheets of drying air, as opposed to air jets, allow the location of probe 50 to vary within body 54 without a detrimental effect on the drying ability. The present invention thus provides a drying action that is less sensitive to probe alignment in the direction of the air slits 78 so that less expensive probe aligning control mechanisms may be employed in analyzer 10. Open shower portion 79 of open well 70 provides a sufficient volume of open space to absorb the entry of the pressurized air from air slits 78 before it is removed through the vacuum port 77, allowing the free flow of the air sheets and preventing the air from splashing water up through opening 81 and out of the washing station 52. The air slits 78 are positioned immediately above the shower opening 76 which advantageously minimizes the area water cannot reach when self-cleaning well 79. Air drying of the probe 50, in addition to reducing carryover of material on the exterior of the probe 50, also significantly reduces the amount of water dilution of the sample or reagent containers on the analyzer 10, thus preventing an adverse affect on accuracy of subsequent chemistry assays It should be noted that the one-piece design of cleansing body 54 greatly reduces the possibility of air leaks that otherwise would reduce the efficacy of the probe drying, a significant problem with multi-piece designs that may employ gaskets or other seals.

Shower water is fed through shower water port 59 and is then immediately divided into two branches 74. The shower water in each branch 74 is further guided into three shower water channels 75 that point upward and are connected to multifunctional plate 80. Once shower water is supplied to the multifunctional plate 80, it circulates locally within four reservoirs 83 (FIGS. 6A and 6B) therein and is then forced by the supply of additional shower water through a thin shower opening 76 into which is an enlarged open shower portion 79 of rinse well 70. The thin shape of shower opening 76 causes pressurized water fed therethrough to form a water shower curtain that has been found to be surprisingly effective in washing probe 50 as well as cleaning the surrounding inner shower water well 79 walls so that no waste build-up is formed. Waste build-up, in addition to reducing the overall performance of the wash station 52, may also cause a sudden and large increase in probe 50 carryover for a given assay if a portion of that build-up adheres to the exterior of probe 50 as it is exiting open well 70, resulting in an abnormally high assay result.

FIG. 5 is a side elevation view of cleansing body 54 in which a pair of branches 74 feeding three channels 75 connecting shower water port 59 to multifunctional plate 80 are shown in phantom lines. Channels 63 connecting air feed port 62 to multifunctional plate 80 are also shown in phantom lines as well as are vacuum lines 69 connecting vacuum port 68 to vacuum ports 77 in the upper portion of wells 70 and 72. FIG. 5A is a sectional view of cleansing body 54 taken along line A-A of FIG. 5 and illustrates air slits 78 at the top of multifunctional plate 80 supplied with pressurized air by channels 63, slits 78 being on opposing sides of a central opening 81 through which probe 50 may be inserted for cleansing in rinse well 70. FIG. 5B is a sectional view of cleansing body 54 taken along line B-B of FIG. 5 and illustrates channels 63 sized and positioned to provide a flow of pressurized air to air slits 78 at the top of multifunctional plate 80. Additionally, FIG. 5C is a sectional view of wash body 54 taken along line C-C of FIG. 5 and illustrates a recess 82 sized to accept multifunctional plate 80 and to connect plate 80 to shower water port 59 by shower water channels 75.

FIG. 6 is a top plan view of multifunctional plate 80 showing a central probe opening 81 for accepting probe 50 and two air slits 78 through which pressurized air supplied by tubing 62T through port 62 into channels 63 flows (as seen in FIG. 5). FIG. 6A is a sectional view of multifunctional plate 80 taken along line A-A of FIG. 6 and illustrates air slits 78 as oriented at a 60 degree angle relative to the direction of probe 50 insertion. FIG. 6A also illustrates two of four reservoirs 83 connected to shower water well 79 by shower opening 76, shower water well 79 sized to mate with enlarged open well portion 79 of rinse well 70. FIG. 6B is a sectional view of multifunctional plate 80 taken along line B-B of FIG. 6 and best illustrates how length of air slits 78 allow the location of probe 50 to vary within body 54 without a detrimental effect on the drying ability.

Cleaning probe 50 comprises descending probe 50 into cleansing well 72 in the cleansing body 54, cleansing well 72 containing a reservoir of probe cleansing solution, typically deionized water, detergent water, Clorox™ solution, alcohol, and/or sodium hydroxide solution A preferable cleansing solution is 2.5-5% sodium hypochlorite or 0.4% sodium hydroxide. While in cleansing well 72, probe 50 aspirates a probe cleansing solution so that both the interior and exterior surfaces are soaked in the cleansing solution for a predetermined length of time. Probe 50 is then removed out of well 72, translated to rinsing well 70, and descended into rinsing well 70, which contains a reservoir of bath water supplied from bath water port 60 through port 71 and maintained at a constant level by the vacuuming action of vacuum port 77 in the upper portion of well 70. Simultaneously, the exposed portion of probe 50 and the enlarged open shower portion 79 at the top of well 70 are showered with water in shower water well 79 using water supplied by water port 59 to branches 74 to shower water channels 75 connected to multifunctional plate 80. Within multifunctional plate 80, shower water circulates locally within reservoirs 83 and is then forced through thin shower opening 76 to form a wall of shower water. This water showering both rinses probe 50 and the upper interior of rinse well 70. Next, a predetermined volume of water is flushed through the interior of probe 50 using the probe's aspiration tubing and into well 70. Finally, another volume of bath water is pumped from bath water port 60 through port 71 to complete the flushing of well 70 with rinsing water. Upon completion of this cycle, probe 50 is withdrawn from well 70 while pressurized air flowing through slits 78 in the form of thin sheets of high velocity air impinges the outer probe surface effectively removing any water droplets on probe 50 outer surface.

Optionally, for those chemistry assays which are less sensitive to probe carryover, the entry into the cleansing solution in cleansing well 72 may be bypassed, using only the water rinse and air dry provided in well 70, thus reducing cleansing time and increasing analyzer throughput.

Washing station 52 has been found to affect a first surprising result of thoroughly reducing carryover between chemistry assays as well as carryover of the washing liquids whereby the accuracy of volume sensitive assays is increased. If analyzer 10 is equipped with cleansing stations 52 of the present invention, it has been discovered that the thin sheets of high velocity air provided by multifunctional plate 80 around withdrawn sample probe 50 is effective in removing liquid therefrom to the extent that less than 0.002 microliters of water is transferred from the exterior of the probe 50 to sample or reagent containers. In addition, carryover of probe cleaning solution from the wash station 52 to the assay reaction vessel 15 is at undetectable levels. When the present invention is employed as described herein, assay to assay carryover in sample volume sensitive assays, most notably for hCG (human Chorionic Gonadotropin), is reduced in the range of less than 1 picoliter of transfer between assays of 2 uL sample size. For less volume sensitive assays where the probe cleaner solution is not utilized, carryover volumes of less than 5 nanoliters were measured in a 20 uL assay. Thus, the combination of thin shower opening 76 of multifunctional plate 80 forming a wall of shower water, coupled with the withdrawal of the sample probe 50 from washing chamber 70 through thin sheets of high velocity air provided by multifunctional plate 80, permits thorough cleaning of the sample probe 50 while increasing the efficiency of the analyzer 10 by minimizing the time necessary for maintenance cleaning.

It should be readily understood by those persons skilled in the art that the present invention is susceptible of a broad utility and application. Many embodiments and adaptations of the present invention other than those herein described, as well as many variations, modifications and equivalent arrangements will be apparent from or reasonably suggested by the present invention and the foregoing description thereof, without departing from the substance or scope of the present invention.

Accordingly, while the present invention has been described herein in detail in relation to specific embodiments, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the claims appended hereto and the equivalents thereof.

What is claimed is:

1. A cleansing station for cleansing and drying a sample probe, the station comprising:
a cleansing body in which probe cleansing, rinsing and drying take place, the cleansing body having attached thereto sources of pressurized air, cleansing solutions, and vacuum for waste removal,
the cleansing body further comprising a multifunctional plate having features for, in combination with said air and cleansing solution sources, providing a shower of cleansing solution and a pressurized flow of drying air, both onto the exterior of a probe inserted into cleansing station.

2. The cleansing station of claim 1 wherein said multifunctional plate is disposed above a vertically oriented, elongate open rinsing well extending partially through the cleansing body, and having an enlarged open shower portion at the upper end thereof for the probe to access.

3. The cleansing station of claim 2 wherein said multifunctional plate comprises a number of reservoirs, the reservoirs connected to the enlarged open shower portion by thin shower openings and to the shower water source.

4. The cleansing station of claim 2 wherein said multifunctional plate further comprises a central probe opening for accepting the probe and air slits through which pressurized air supplied by the pressurized air source flows, the air slits oriented at a 60 degree angle relative to the direction of probe insertion.

5. The cleansing station of claim 4 wherein the air slits are oriented at a 60 degree angle relative to the direction of probe insertion.

6. The cleansing station of claim 2 wherein said cleansing multifunctional plate is embedded in said cleansing station body resulting in a one-piece cleansing body without additional seals.

7. The cleansing station of claim 2 wherein said shower portion creates a shower of rinsing water to provide a self-cleaning function to the interior of the open rinsing well.

8. The cleansing station of claim 2 wherein a second vertically oriented, elongate open well contains a secondary probe cleaning solution.

9. The cleansing station of claim 1 wherein said multiple sources of pressurized air and cleansing solutions are provided with a single connection.

10. The cleansing station of claim 1 wherein one cleansing solution is water.

11. The cleansing station of claim 2 wherein the open rinsing well additionally contains a pool of rinsing solution refillable from the bottom of the well.
